(19) United States
(12) Patent Application Publication
(10) Pub. No.: US 2018/0361640 A1
(43) Pub. Date: Dec. 20, 2018

(54) ONE-STEP INJECTION MOLDING MOLD OF TUBULAR PRODUCT AND MOLDING METHOD THEREOF

(71) Applicant: BAOCHENG PRECISION MOULD INDUSTRIAL LIMITED, Shenzhen, Guangdong (CN)

(72) Inventor: Chengfang YI, Shenzhen (CN)

(73) Assignee: BAOCHENG PRECISION MOULD INDUSTRIAL LIMITED, Shenzhen, Guangdong (CN)

(21) Appl. No.: 15/567,591

(22) PCT Filed: Jun. 20, 2017
(86) PCT No.: PCT/CN2017/089186

§ 371 Date: Oct. 18, 2017

(51) Int. Cl. B29C 45/26; B29C 45/36; B29C 45/17; B29C 45/27

(52) U.S. Cl. CPC B29C 45/261; B29C 45/36; B29C 2045/2689; B29C 45/2708; B29C 2045/2709; B29C 45/1744

(57) ABSTRACT

A one-step injection molding mold of a tubular product. The mold divides a product into two parts for one-step injection molding, and includes a mounting retainer plate, runner stripper plate, front and rear mold plates, ejector retainer plate, ejector baseplate and a mounting baseplate, which are stacked, wherein the ejector retainer plate and baseplate are fixed together, two side edges thereof having square blocks, a first and a second hydraulic cylinder are arranged at the top of the mold, a third hydraulic cylinder is arranged on the external side surface of the mounting baseplate, and a fourth hydraulic cylinder is arranged on one side surface of the front mold plate adjacent to the rear mold plate. Further, a one-step injection molding method of a tubular product, including steps 1-6. The mold and the molding method thereof may increase the product yield and ensure a safe production process.

### TECHNICAL FIELD

The present invention relates to an injection molding mold, and more particularly to a one-step injection molding mold of a tubular product and a molding method thereof.

### BACKGROUND

As to the existing technical solution at present, FIG. 1a is a structural schematic diagram of a tubular product; FIG. 1b is a sectional view along an M-M line in FIG. 1a, which shows that a tubular product in the prior art is divided into a part A and a part B for injection molding; product A is manufactured first, then product A is put in a mold for encapsulation, and product B is manufactured, so that one-step injection molding cannot be implemented. According to the existing technical solution, when product B is subjected to injection molding, product A is deformed due to the influence of the pressure from injection molding, so that the inside of the product may be damaged and then the product may not be used, thereby causing low product yield. As there is a need to put the product A in the mold when product B is subjected to injection molding, it is easy for the machine to fall over to cause tremendous accident, thereby reducing the safety of the production process of the product.

### SUMMARY

In view of this, the main purpose of the present invention is to provide a one-step injection molding mold of a tubular product having high product yield and safe production process and a molding method thereof.

To achieve the above-mentioned purpose, the present invention provides a one-step injection molding mold of a tubular product, wherein the one-step injection molding mold divides a product into two parts for one-step injection molding, and includes a mounting retainer plate, a runner stripper plate, a front mold plate, a rear mold plate, an ejector retainer plate, an ejector baseplate and a mounting baseplate which are arranged in sequence in a stacked structure, wherein the ejector retainer plate and the ejector baseplate are fixed together, two side edges of the ejector retainer plate and the ejector baseplate are respectively provided with square blocks, a first hydraulic cylinder and a second hydraulic cylinder are arranged at the top of the mold, a third hydraulic cylinder is arranged on the external side surface of the mounting baseplate, and a fourth hydraulic cylinder is arranged on one side surface of the front mold plate, adjacent to the rear mold plate; a first cavity and a second cavity for injection molding the two parts of the product are respectively arranged between the front mold plate and the rear mold plate and the first cavity and the second cavity are in central symmetry, a first gate and a second gate are respectively arranged on the front mold plate, in the middle of the first cavity and at one side of the second cavity, and the first gate and the second gate are used for casting the two parts of the product respectively; and the rear mold plate, the ejector retainer plate and the ejector baseplate are fixed to a movable mold plate of an injection molding machine by the mounting baseplate.

Preferably, a locating ring is arranged in the middle of the mounting retainer plate, and the locating ring is used for installing the mold on the injection molding machine in a locating manner, so as to enable a nozzle of the injection molding machine to be aligned with an injection port of the mold.

Preferably, the front mold plate is provided with a front mold core, the rear mold plate is provided with a rear mold core corresponding to the front mold core, and the first cavity and the second cavity are formed between the front mold core and the rear mold core after mold closing.

Preferably, a row of multiple ejector pins are fixedly arranged, in the position relative to the second cavity, on the ejector retainer plate, both the upper end and the lower end between the ejector retainer plate and the rear mold plate are provided with reset springs, the injection molded product is ejected by the ejector pins during mold opening, the ejector pins are reset by the reset springs, and the reset springs reset the ejector pins.

Preferably, insert pin pressing plates are respectively arranged, in the position relative to the first cavity and the second cavity, on the rear mold plate, and each insert pin pressing plate is fixedly provided with a row of multiple insert pins.

Preferably, a runner switch is arranged, at one side of the injection port, on the front mold plate, and the runner switch is perpendicular to the front mold core.

Preferably, the first gate and the second gate are respectively connected to a first gate bushing and a second gate bushing, each end of the first gate bushing and the second gate bushing is respectively connected to different lock pins, the lock pins are fixedly arranged on the pressing plates, and after one-step injection molding is completed, the first gate and the second gate are made to be separated from the first cavity and the second cavity respectively by the lock pins corresponding thereto.

Preferably, a first slide block, a second slide block, a third slide block, a fourth slide block and a fifth slide block are respectively arranged between the front mold plate and the rear mold plate, and a push bar rotating shaft is vertically arranged in the middle position of the rear mold core in an outward extension mode.

Preferably, a gear, a first guide bushing and a second guide bushing are respectively arranged at the outer side of the push bar rotating shaft, a rack is arranged at one side of the gear, the gear is engaged with the rack, the push bar rotating shaft is driven to rotate under the transmission of the gear and the rack, so that the rear mold core rotates along with the push bar rotating shaft, and the first cavity and the second cavity are still formed between the rear mold core and the front mold core after the rear mold core rotates for 180° along with the push bar rotating shaft.

Preferably, the first slide block, the third slide block and the fourth slide block are respectively arranged on three side surfaces of the rear mold core adjacent to the first cavity, and the second slide block and the fifth slide block are respectively arranged on the two side surfaces of the rear mold core adjacent to the second cavity.

Preferably, a first guide pillar and a second guide pillar are respectively arranged between the front mold plate and the rear mold plate close to the third slide block and the fourth slide block; a first angular guide pillar groove and second angular guide pillar groove are respectively arranged in the second slide block and the fifth slide block, the first angular guide pillar groove and the second angular guide pillar groove obliquely extend to the front mold plate, and are respectively provided with a first angular guide pillar and a second angular guide pillar corresponding thereto, and the first angular guide pillar and the second angular guide pillar guide and drive to make the second slide block and the fifth slide block slide outwards for expansion or slide inwards for gathering.

Preferably, a first hydraulic cylinder lever is connected between the first hydraulic cylinder and the first slide block, two hydraulic cylinder fixing plates are arranged between the first hydraulic cylinder and the first hydraulic cylinder lever, and a switch is arranged at a side, close to the first hydraulic cylinder, of the hydraulic cylinder fixing plate; a second hydraulic cylinder lever is connected between the second hydraulic cylinder and the rear mold plate, and one of the hydraulic cylinder fixing plates is arranged between the second hydraulic cylinder and the second hydraulic cylinder lever; a third hydraulic cylinder lever is connected between a third hydraulic cylinder and the push bar rotating shaft; a fourth hydraulic cylinder lever is connected between the fourth hydraulic cylinder and the fourth slide block, and the two hydraulic cylinder fixing plates are arranged between the fourth hydraulic cylinder and the fourth hydraulic cylinder lever; and each of one side of the first slide block and one side of the second hydraulic cylinder lever is provided with a switch fixing plate.

The present invention also provides a one-step injection molding method of a tubular product. The product is divided into a body 1 and a body 2 for one-step injection molding in the method, comprising the following steps:

step 1: closing mold: the first slide block, the second slide block, the third slide block, the fourth slide block and the fifth slide block are all in a core feeding state, both the first cavity and the second cavity are hollow, the runner switch is switched off to fill plastic through the first gate only, and body 1 of the product is molded in the first cavity;

step 2: manually switching on the runner switch;

step 3: opening mold: the first hydraulic cylinder, the second hydraulic cylinder, the third hydraulic cylinder, the fourth hydraulic cylinder, the first angular guide pillar and the second angular guide pillar drive the first slide block, the second slide block, the third slide block, the fourth slide block and the fifth slide block to slide outwards for expansion, the rear mold core is ejected out of the mold frame by the push bar rotating shaft, the rear mold core is driven to rotate for 180° around the push bar rotating shaft under the transmission of the rack and gear, and then the rear mold core is pulled back into the mold frame by the push bar rotating shaft to enable body 1 of the product molded at the first gate in step 1 to rotate to the second cavity at the other side along with the rotation of the rear mold core;

step 4: closing mold: the first hydraulic cylinder, the second hydraulic cylinder, the third hydraulic cylinder, the fourth hydraulic cylinder, the first angular guide pillar and the second angular guide pillar drive the first slide block, the second slide block, the third slide block, the fourth slide block and the fifth slide block to slide inwards for gathering, to fill plastic through the first gate and the second gate simultaneously, body 1 of the product is molded at the first gate in the first cavity, while body 2 of the product is molded at the second gate in the second cavity;

step 5: opening mold: ejecting the complete product molded in the second cavity; and

step 6: repeating actions in step 3 to step 5, and repeating in this way for continuous production.

For the one-step injection molding mold of a tubular product and the molding method thereof of the present invention, a product may be divided into two parts for one-step injection molding, deformation due to the influence of the pressure from injection molding and damage to the inside of the product may be avoided, so that the product yield is increased, and the production process is safe.

### DESCRIPTION OF THE DRAWINGS

FIG. 1a is a structural schematic diagram of a tubular product;

FIG. 1b is a sectional view along an M-M line in FIG. 1a, which shows that a tubular product in the prior art is divided into a part A and a part B for injection molding;

FIG. 2 is a sectional view along an M-M line in FIG. 1a, which shows that a tubular product in the present invention is divided into a part C and a part D for injection molding;

FIG. 3 is a side sectional view of a one-step injection molding mold of a tubular product of the present invention;

FIG. 4 is a top sectional view of a one-step injection molding mold of a tubular product of the present invention;

FIG. 5 is a top local sectional view of a one-step injection molding mold of a tubular product of the present invention; and

FIG. 6 is a top local sectional view of a one-step injection molding mold of a tubular product of the present invention.

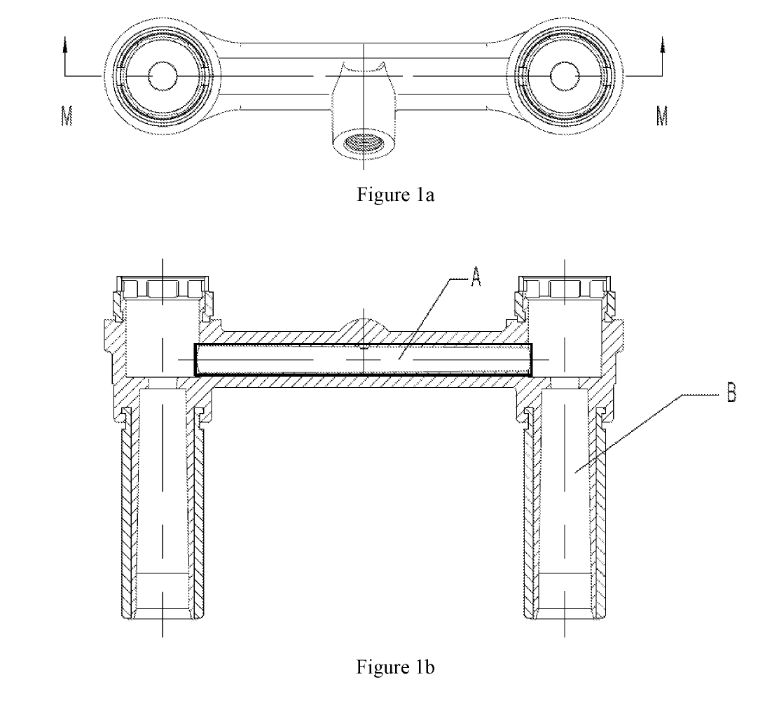

### DETAILED DESCRIPTION

To make the purpose, the technical solution and the advantages of the embodiments of the present invention more clear, the technical solution in the embodiments of the present invention will be clearly and completely described below in combination with the drawings in the embodiments of the present invention.

Embodiments of the present invention will be described below in detail. Examples of the embodiments are shown in the figures, wherein the same or similar reference signs refer to same or similar elements or elements having the same or similar functions from the beginning to the end. Embodiments described below through reference figures are exemplary embodiments, are only used for explaining the present invention, rather than for limiting the present invention.

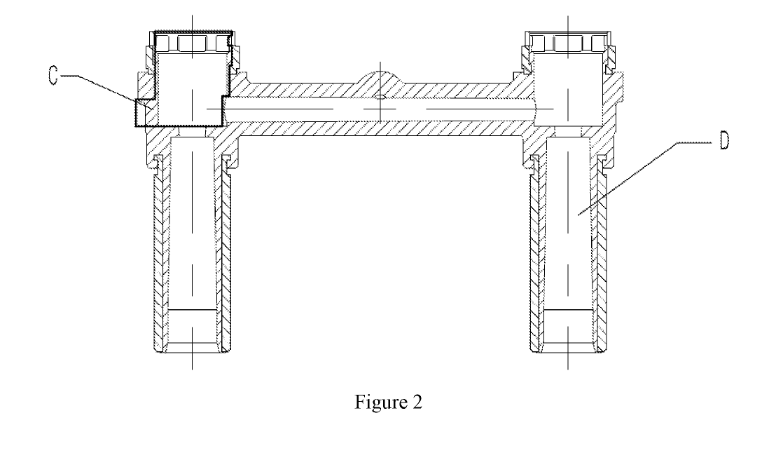

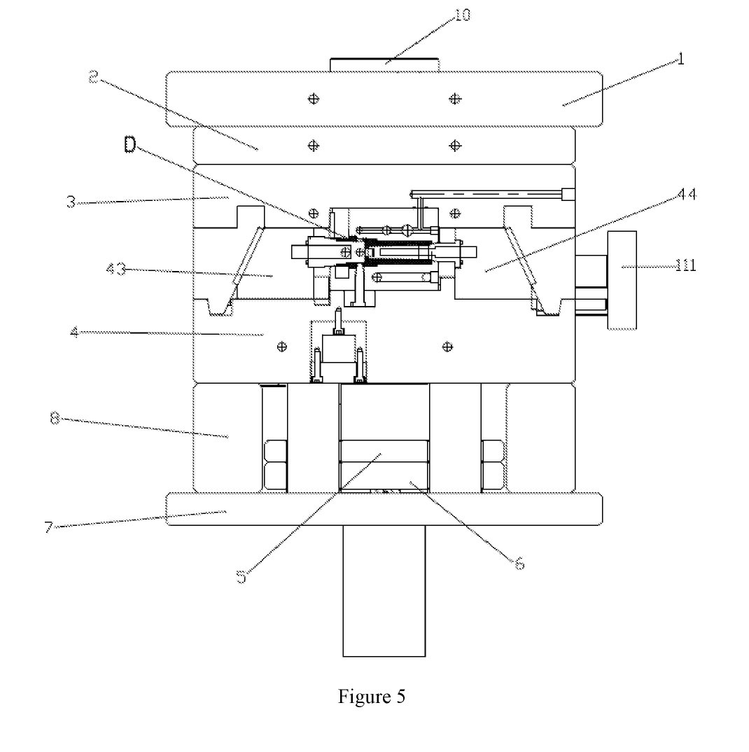

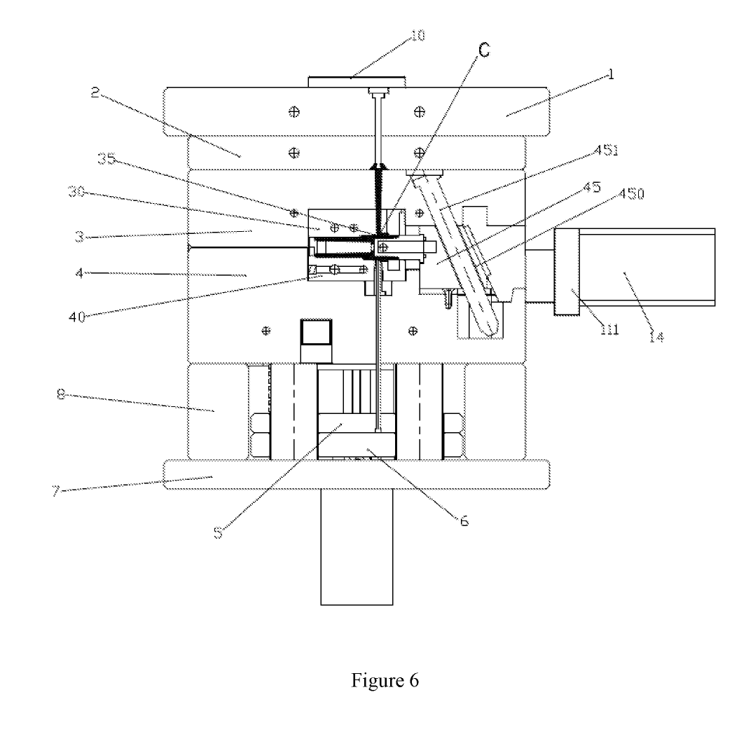

As shown in FIG. 2 to FIG. 6, for the one-step injection molding mold of a tubular product of the present invention, the product is divided into two parts for one-step injection molding, i.e., body 1 (D in FIG. 2) and body 2 (C in FIG. 2). The molding mold includes a mounting retainer plate 1, a runner stripper plate 2, a front mold plate 3, a rear mold plate 4, an ejector retainer plate 5, an ejector baseplate 6 and a mounting baseplate 7 which are arranged in sequence in a stacked structure, wherein the ejector retainer plate 5 and the ejector baseplate 6 are fixed together, the two side edges of the ejector retainer plate 5 and the ejector baseplate 6 are respectively provided with square blocks 8, a first hydraulic cylinder 11 and a second hydraulic cylinder 12 are arranged at the top of the mold, a third hydraulic cylinder 13 is arranged on the external side surface of the mounting baseplate 7, and a fourth hydraulic cylinder 14 is arranged on one side surface of the front mold plate 3, adjacent to the rear mold plate 4. The mounting baseplate 7 is used for fixing the rear mold plate 4, the ejector retainer plate 5 and the ejector baseplate 6 to a movable mold plate of an injection molding machine.

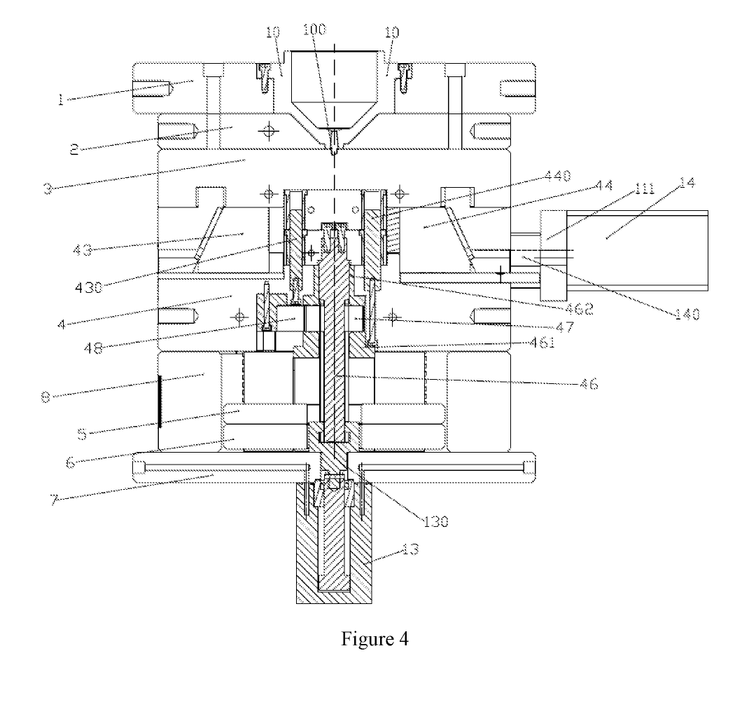

As shown in FIG. 4, a locating ring 10 is arranged in the middle of the mounting retainer plate 1, and the locating ring is used for installing the mold on the injection molding machine in a locating manner, so as to enable a nozzle of the injection molding machine to be aligned with an injection port 100 of a mold runner system.

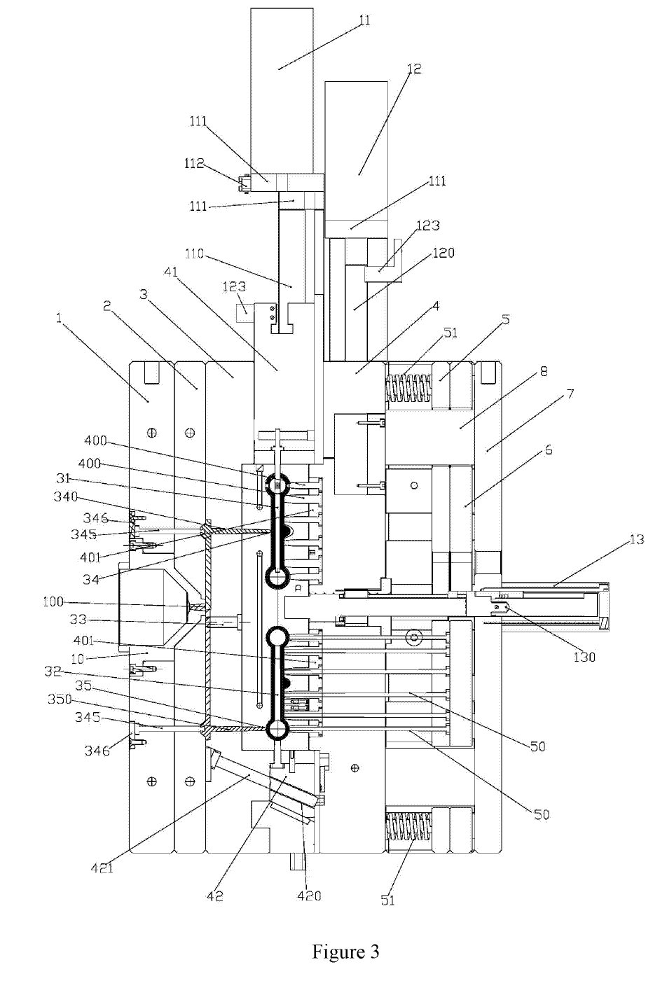

As shown in FIG. 3, the front mold plate 3 is provided with a front mold core 30, the rear mold plate 4 is provided with a rear mold core 40 corresponding to the front mold core 30, and the first cavity 31 and the second cavity 32 which are in central symmetry are formed between the front mold core 30 and the rear mold core 40 after mold closing. A runner switch 33, perpendicular to the front mold core 30, is arranged at one side of the injection port 100 on the front mold plate 3, and the runner switch 33 is used for controlling the plastic filling state of the runner system.

As shown in FIG. 3, a first gate 34 and a second gate 35 are respectively arranged on the front mold plate 3, in the middle of the first cavity 31 and at one side of the second cavity 32, the first gate 34 is used for the injection molding of product D, while the second gate 35 is used for the injection molding of product C, the first gate 34 and the second gate 35 are respectively connected to a first gate bushing 340 and a second gate bushing 350, each end of the first gate bushing 340 and the second gate bushing 350 is respectively connected to lock pins 345, and the lock pins 345 are fixedly arranged on the pressing plates 346. After one-step injection molding is completed, the first gate 34 and the second gate 35 are respectively separated from the first cavity 31 and the second cavity 32 by lock pins 345 for the next injection molding.

A first slide block 41, a third slide block 43 and a fourth slide block 44 are respectively arranged on three side surfaces of the rear mold core 40 adjacent to the first cavity 31 between the front mold plate 3 and the rear mold plate 4, and a second slide block 42 and a fifth slide block 45 are respectively arranged on two side surfaces, adjacent to the second cavity, of the rear mold core 40. A push bar rotating shaft 46 is vertically arranged in the middle position of the rear mold core 40 in an outward extension mode, a gear 47, a first guide bushing 461 and a second guide bushing 462 are respectively arranged at the outer side of the push bar rotating shaft 46, a rack 48 is arranged at one side of the gear 47, the gear 47 is engaged with the rack 48, the push bar rotating shaft 46 is driven to rotate under the transmission of the gear 47 and the rack 48, so that the rear mold core 40 rotates along with the push bar rotating shaft 46, and in the process of injection molding, the first cavity 31 and the second cavity 32 identical to those before rotation are still formed between the rear mold core 40 and the front mold core 30 after the rear mold core 40 rotates for 180° along with the push bar rotating shaft 46, therefore, the injection molded product may be continuously circulated.

A first guide pillar 430 and a second guide pillar 440 are respectively arranged, close to the third slide block 43 and the fourth slide block 44, between the front mold plate 3 and the rear mold plate 4.

A first angular guide pillar groove 420 and a second angular guide pillar groove 450 are respectively arranged in the second slide block 42 and the fifth slide block 45, and the first angular guide pillar groove 420 and the second angular guide pillar groove 450 obliquely extend to the front mold plate 3, and are respectively provided with a first angular guide pillar 421 and a second angular guide pillar 451 corresponding thereto. In the process of switching between mold opening and mold closing, the first angular guide pillar 421 and the second angular guide pillar 451 guide and drive the second slide block 42 and the fifth slide block 45 to slide outwards for expansion or slide inwards for gathering.

A first hydraulic cylinder lever 110 is connected between the first hydraulic cylinder 11 and the first slide block 41, two hydraulic cylinder fixing plates 111 are arranged between the first hydraulic cylinder 11 and the first hydraulic cylinder lever 110, and a switch 112 is arranged at one side, close to the first hydraulic cylinder 11, of the hydraulic cylinder fixing plate 111. A second hydraulic cylinder lever 120 is connected between the second hydraulic cylinder 12 and the rear mold plate 4, and one of the hydraulic cylinder fixing plates 111 is arranged between the second hydraulic cylinder 12 and the second hydraulic cylinder lever 120. A third hydraulic cylinder lever 130 is connected between the third hydraulic cylinder 13 and the push bar rotating shaft 46. A fourth hydraulic cylinder lever 140 is connected between the fourth hydraulic cylinder 14 and the fourth slide block 44, and the two hydraulic cylinder fixing plates 111 are arranged between the fourth hydraulic cylinder 14 and the fourth hydraulic cylinder lever 140. Each of the one side of the first slide block 41 and one side of the second hydraulic cylinder lever 120 is provided with a switch fixing plate 123.

A row of multiple ejector pins 50 are fixedly arranged, in the position relative to the second cavity 32, on the ejector retainer plate 5, both the upper end and the lower end between the ejector retainer plate 5 and the rear mold plate 4 are provided with reset springs 51, the injection molded product is ejected by the ejector pins 50 during mold opening, and the reset springs 51 are used for resetting the ejector pins 50.

Insert pin pressing plates 400 are respectively arranged, in the positions relative to the first cavity 31 and the second cavity 32, on the rear mold plate 4, and each insert pin pressing plate 400 is fixedly provided with a row of multiple insert pins 401. The insert pins 401 cooperate with the ejector pins 50 to eject the injection molded product.

Embodiments of the present invention also provide a one-step injection molding method of a tubular product, comprising the following steps:

step 1: closing mold: the first slide block 41, the second slide block 42, the third slide block 43, the fourth slide block 44 and the fifth slide block 45 are all in a core feeding state, then both the first cavity 31 and the second cavity 32 of the mold are hollow at this time, the runner switch 33 is switched off to fill plastic through the first gate 34 only, and part D of the product is molded in the first cavity 31;

step 2: manually switching on the runner switch 33;

step 3: opening mold: the first hydraulic cylinder 11, the second hydraulic cylinder 12, the third hydraulic cylinder 13, the fourth hydraulic cylinder 14, the first angular guide pillar 421 and the second angular guide pillar 451 drive the first slide block 41, the second slide block 42, the third slide block 43, the fourth slide block 44 and the fifth slide block 45 to slide outwards for expansion, the rear mold core 40 is ejected out of the mold frame by the push bar rotating shaft 46, the rear mold core 40 is driven to rotate for 180° around the push bar rotating shaft 46 under the transmission of the rack 48 and the gear 47, and then the rear mold core 40 is pulled back into the mold frame by the push bar rotating shaft 46 to enable product D molded at the first gate 34 in step 1 to rotate to the second cavity 32 at the other side along with the rotation of the rear mold core 40;

step 4: closing mold: the first hydraulic cylinder 11, the second hydraulic cylinder 12, the third hydraulic cylinder 13, the fourth hydraulic cylinder 14, the first angular guide pillar 421 and the second angular guide pillar 451 drive the first slide block 41, the second slide block 42, the third slide block 43, the fourth slide block 44 and the fifth slide block 45 to slide inwards for gathering, to fill plastic through the first gate 34 and the second gate 35 simultaneously, a product D is continuously molded at the first gate 34 in the first cavity 31, while a product C is molded at the second gate 35 in the second cavity 32;

step 5: opening mold: ejecting the complete product molded in the second cavity 32; and

step 6: repeating actions in step 3 to step 5, and repeating in this way for continuous production.

The one-step injection molding mold of a tubular product of the present invention may be used for performing one-step injection molding on tube products, for example, taps and other multi-valve tubes.

Therefore, for the one-step injection molding mold of a tubular product and molding method thereof of the present invention, a product may be divided into two parts for one-step injection molding, deformation due to the influence of the pressure from injection molding and damage to the inside of the product may be avoided, so that the product yield can be increased, and the production process is safe.

What is described above is merely preferred embodiments of the present invention, rather than limiting the protection scope of the present invention.

1. A one-step injection molding mold of a tubular product, the one-step injection molding mold divides a product into two parts for one-step injection molding, wherein it comprises a mounting plate, a runner stripper plate, a front mold plate, a rear mold plate, an ejector retainer plate, an ejector baseplate and a mounting baseplate which are arranged in sequence in a stacked structure, the ejector retainer plate and the ejector baseplate are fixed together, two side edges of the ejector retainer plate and the ejector baseplate are respectively provided with square blocks, a first hydraulic cylinder and a second hydraulic cylinder are arranged at the top of the mold, a third hydraulic cylinder is arranged on the external side surface of the mounting baseplate, and a fourth hydraulic cylinder is arranged on one side surface of the front mold plate adjacent to the rear mold plate; a first cavity and a second cavity for the injection molding of two parts of the product respectively are arranged between the front mold plate and the rear mold plate, and the first cavity and the second cavity are in central symmetry, and a first gate and a second gate are respectively arranged on the front mold plate, in the middle of the first cavity and at one side of the second cavity, and the first gate and the second gate are used for casting the two parts of the product respectively; and the rear mold plate, the ejector retainer plate and the ejector baseplate are fixed to a movable mold plate of an injection molding machine by the mounting baseplate.

2. The one-step injection molding mold of a tubular product of claim 1, wherein a locating ring is arranged in the middle of the mounting retainer plate, and the locating ring is used for installing the mold on the injection molding machine in a locating manner, so as to enable a nozzle of the injection molding machine to be aligned with an injection port of the mold.

3. The one-step injection molding mold of a tubular product of claim 1, wherein the front mold plate is provided with a front mold core, the rear mold plate is provided with a rear mold core corresponding to the front mold core, and the first cavity and the second cavity are formed between the front mold core and the rear mold core after mold closing.

4. The one-step injection molding mold of a tubular product of claim 3, wherein a row of multiple ejector pins are fixedly arranged, in the position relative to the second cavity, on the ejector retainer plate, both the upper end and the lower end between the ejector retainer plate and the rear mold plate are provided with reset springs, the injection molded product is ejected by the ejector pins during mold opening, and the reset springs reset the ejector pins.

5. The one-step injection molding mold of a tubular product of claim 3, wherein insert pin pressing plates are respectively arranged, in the position relative to the first cavity and the second cavity, on the rear mold plate, and the insert pin pressing plates are fixedly provided with a row of multiple insert pins.

6. The one-step injection molding mold of a tubular product of claim 2, wherein a runner switch is arranged, at one side of the injection port, on the front mold plate, and the runner switch is perpendicular to the front mold core.

7. The one-step injection molding mold of a tubular product of claim 1, wherein the first gate and the second gate are respectively connected to a first gate bushing and a second gate bushing, each end of the first gate bushing and the second gate bushing is respectively connected to different lock pins, the lock pins are fixedly arranged on the pressing plates, and after one-step injection molding is completed, the first gate and the second gate are made to be separated from the first cavity and the second cavity respectively by the lock pins corresponding thereto.

8. The one-step injection molding mold of a tubular product of claim 3, wherein a first slide block, a second slide block, a third slide block, a fourth slide block and a fifth slide block are respectively arranged between the front mold plate and the rear mold plate, and a push bar rotating shaft is vertically arranged in the middle position of the rear mold core in an outward extension mode.

9. The one-step injection molding mold of a tubular product of claim 8, wherein a gear, a first guide bushing and a second guide bushing are respectively arranged at outersides of the push bar rotating shaft, a rack is arranged at one side of the gear, the gear is engaged with the rack, the push bar rotating shaft is driven to rotate under the transmission of the gear and the rack, so that the rear mold core rotates along with the push bar rotating shaft, and the first cavity and the second cavity are still formed between the rear mold core and the front mold core after the rear mold core rotates for 180° along with the push bar rotating shaft.

10. The one-step injection molding mold of a tubular product of claim 8, wherein the first slide block, the third slide block and the fourth slide block are respectively arranged on three side surfaces of the rear mold core adjacent to the first cavity, and the second slide block and the fifth slide block are respectively arranged on the two side surfaces of the rear mold core adjacent to the second cavity.

11. The one-step injection molding mold of a tubular product of claim 10, wherein a first guide pin and a second guide pin are respectively arranged between the front mold plate and the rear mold plate, close to the third slide block and the fourth slide block; a first angular guide pillar groove and a second angular guide pillar groove are respectively arranged in the second slide block and the fifth slide block, the first angular guide pillar groove and the second angular guide pillar groove obliquely extend to the front mold plate, and are respectively provided with a first angular guide pin and a second angular guide pillar corresponding thereto, and the first angular guide pillar and the second angular guide pillar guide and drive to make the second slide block and the fifth slide block slide outwards for expansion or slide inwards for gathering.

12. The one-step injection molding mold of a tubular product of claim 10, wherein a first hydraulic cylinder lever is connected between the first hydraulic cylinder and the first slide block, two hydraulic cylinder fixing plates are arranged between the first hydraulic cylinder and the first hydraulic cylinder lever, and a switch is arranged at a side, close to the first hydraulic cylinder, of the hydraulic cylinder fixing plate; a second hydraulic cylinder lever is connected between the second hydraulic cylinder and the rear mold plate, and a hydraulic cylinder fixing plate is arranged between the second hydraulic cylinder and the second hydraulic cylinder lever; a third hydraulic cylinder lever is connected between a third hydraulic cylinder and the push bar rotating shaft; a fourth hydraulic cylinder lever is connected between the fourth hydraulic cylinder and the fourth slide block, and two hydraulic cylinder fixing plates are arranged between the fourth hydraulic cylinder and the fourth hydraulic cylinder lever; and one side of the first slide block and one side of the second hydraulic cylinder lever is provided with a switch fixing plate, respectively.

13. A one-step injection molding method of a tubular product of one-step injection molding mold of claim 1 wherein the product is divided into a body 1 and a body 2 for one-step injection molding in the method, comprising the following steps:
step 1: closing mold: the first slide block, the second slide block, the third slide block, the fourth slide block and the fifth slide block are all in a core feeding state, both the first cavity and the second cavity are hollow, the runner switch is switched off to fill plastic through the first gate only, and body 1 of the product is molded in the first cavity;
step 2: manually switching on the runner switch;
step 3: opening mold: the first hydraulic cylinder, the second hydraulic cylinder, the third hydraulic cylinder, the fourth hydraulic cylinder, the first angular guide pillar and the second angular guide pillar drive the first slide block, the second slide block, the third slide block, the fourth slide block and the fifth slide block to slide outwards for expansion, the rear mold core is ejected out of the mold frame by the push bar rotating shaft, the rear mold core is driven to rotate for 180° around the push bar rotating shaft under the transmission of the rack and gear, and then the rear mold core is pulled back into the mold frame by the push bar rotating shaft to enable body 1 of the product molded at the first gate in step 1 to rotate to the second cavity at the other side along with the rotation of the rear mold core;
step 4: closing mold: the first hydraulic cylinder, the second hydraulic cylinder, the third hydraulic cylinder, the fourth hydraulic cylinder, the first angular guide pillar and the second angular guide pillar drive the first slide block, the second slide block, the third slide block, the fourth slide block and the fifth slide block to slide inwards for gathering, the first gate and the second gate are filled with plastics simultaneously, body 1 of the product is molded at the first gate in the first cavity, while body 2 of the product is molded at the second gate in the second cavity;
step 5: opening mold: ejecting the complete product molded in the second cavity; and
step 6: repeating operations in step 3 to step 5, and repeating in this way for continuous production.

14. The one-step injection molding mold of a tubular product of claim 3, wherein a runner switch is arranged, at one side of the injection port, on the front mold plate, and the runner switch is perpendicular to the front mold core.
